(19) United States
(12) Patent Application Publication
(10) Pub. No.: US 2025/0231911 A1
(43) Pub. Date: Jul. 17, 2025

(54) CREATING A FILE DATA RECORD BASED ON AN INTERNAL FILE TEMPLATE

(71) Applicant: Microsoft Technology Licensing, LLC, Redmond, WA (US)

(72) Inventors: Omar CAREY, Redmond, WA (US); Rajsekhar DAS, Sammamish, WA (US); Neeraj Kumar SINGH, Seattle, WA (US)

(21) Appl. No.: 18/730,723

(22) PCT Filed: Feb. 3, 2023
(86) PCT No.: PCT/US2023/061908

§ 371 Date: Jul. 19, 2024

(30) Foreign Application Priority Data
Feb. 4, 2022 (LU) LU501387

(51) Int. Cl. G06F 16/16; G06F 9/54; G06F 16/13; G06F 16/18

(52) U.S. Cl. CPC G06F 16/16; G06F 16/13; G06F 16/1865

(57) ABSTRACT

Methods, systems, and computer program products for creating a file system file data record based on an internal file template. A computer system identifies an application programming interface (API) request to create a new file. Based at least on identifying the API request, the computer system determines a set of attributes associated with the new file. The computer system also identifies a selected file template, from among a set of file templates, that is associated with the set of attributes. The computer system creates a file data record for the new file within a file system database, including inserting a copy of the selected file template into the file data record for the new file.

### TECHNICAL FIELD

The present disclosure relates to systems, methods, and devices that create file data records within a file system database.

### BACKGROUND

Computer systems commonly store data on, and access data from, a computer storage medium. When doing so, computer systems often utilize file systems to organize data stored on that computer storage medium into files, which can be further organized hierarchically within volumes, directories, and the like. File systems include one or more software components (e.g., an operating system driver, user space tools, etc.) that operate to manage and interact with one or more stored data structures (e.g., also stored in the computer storage medium) that define the structure of the file system. These stored data structure(s) make up a file system database that comprises a file data record for each file that is managed by the file system. Each file data record stores multiple data elements, such as attributes. Example attributes include a file name, a file creation time, a file access time, a file modification time, one or more sets of file permissions, a security descriptor, integrity protection status, compression status, and the like. Attributes also identify the physical location(s) on the computer storage medium corresponding to the file's data. The structure of a file system database—including the format of the data structure(s) making up the file system database, the file data records contained within the file system database, and the like—vary widely depending on file system design and implementation choices.

Creating a new file within a file system involves creating an empty file data record, and then adding individual attributes of the file to that file data record using multiple operations.

For example, a file system driver allocates an empty file data record within data structure(s) making up the file system database, and then uses a plurality of database operations to add individual initial file attributes (e.g., file name, creation time, file permissions) to that file data record.

### BRIEF SUMMARY

Creation of a file data record involves multiple operations on a file system database. These database operations include, for example, one or more database operations to create an empty file data record within the file system database, and then a different database operation to write each of a plurality of individual initial file attributes to that file data record. Each of these database operations incurs processing and storage overheads. These overheads are amplified in modern file systems that implement a transactional file system database. For example, in addition to the overheads of performing the operation itself, each transactional database operation also causes a lock on the file system database (i.e., to prevent other operations from modifying the file system database until the operation completes) and causes the logging of each operation, such as by creating of an undo and redo record pair for each operation. Thus, creation of new files can cause significant overheads in terms of data storage (e.g., for multiple undo and redo record pairs), processor usage (e.g., for implementing locks and the creation of undo and redo log records), and corresponding energy usage.

The inventors have recognized that, typically, files are created with a standard set of attributes that have default values. For example, most files are created using a small set of operating system application programming interfaces (APIs). Each of these APIs, when used to create new files, each cause creation of files having a standard set of attributes that have default values for that API. Utilizing this observation, at least some embodiments described herein create a set of internal file “templates” that each has common sets of attributes for newly created files (e.g., when using operating system APIs). Then, when a new file is being created that has one of these common sets of attributes, the embodiments described herein copy an appropriate file template into a new file data record in a single transaction within a file system database (i.e., a single atomic database operation from the point of view of crash recovery and file system transactional semantics), rather than using multiple transactions to write those attributes to the new file data record, as was done previously. In embodiments, the file template can be “patched up” with unique data—such as file name, file creation time, and the like—prior copying it into a new file data record. On a benchmark workload, the template approach described herein improves the performance of creating a new file by 25%.

Notably, creating a new file data record using a single transaction within a file system database—rather than using multiple database transactions as was done previously—leads to a reduction of data stored in a transaction log (e.g., a single undo and redo record pair for the single transaction, rather than a different undo and redo record pair for each of a plurality of database transactions), and a reduction of work on crash recovery (e.g., less transaction log data to replay). Creating a new file data record as a single transaction also takes a single lock on the file system database (e.g., when copying a template into a file data record), rather than taking multiple locks on the file system database (e.g., as each attribute that is added to a file data record) as was done previously. Overall, this leads to reduced data storage requirements, more efficient use of processor resources, and lower energy use than prior file creation techniques.

In some aspects, the techniques described herein relate to a method, implemented at a computer system that includes a processor, for creating a file system file data record based on a file template, the method including: identifying an API request to create a new file; based at least on identifying the API request, identifying a set of attributes associated with the new file; identifying a selected file template, from among a set of file templates, that is associated with the set of attributes; and creating a file data record for the new file within a file system database, including inserting a copy of the selected file template into the file data record for the new file.

In some aspects, the techniques described herein relate to a computer system for creating a file system file data record based on a file template, including: a processor; and a computer storage media that stores computer-executable instructions that are executable by the processor to cause the computer system to at least: identify an API request to create a new file; based at least on identifying the API request, identify a set of attributes associated with the new file; identify a selected file template, from among a set of file templates, that is associated with the set of attributes; and create a file data record for the new file within a file system database, including inserting a copy of the selected file template into the file data record for the new file.

In some aspects, the techniques described herein relate to a computer program product including a computer storage media that stores computer-executable instructions that are executable by a processor to cause a computer system to create a file system file data record based on a file template, the computer-executable instructions including instructions that are executable by the processor to cause the computer system to at least: identify an API request to create a new file; based at least on identifying the API request, identify a set of attributes associated with the new file; identify a selected file template, from among a set of file templates, that is associated with the set of attributes; and create a file data record for the new file within a file system database, including inserting a copy of the selected file template into the file data record for the new file.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates creating a file system file data record based on an internal file template;

FIG. 2A illustrates an example of template creation logic;

FIG. 2B illustrates an example of file creation logic that leverages file templates;

FIG. 3 illustrates an example of inserting a file template into a file data record;

FIG. 4 illustrates a flow chart of an example method for creating a file template; and

FIG. 5 illustrates a flow chart of an example method for creating a file system file data record based on a file template.

### DETAILED DESCRIPTION

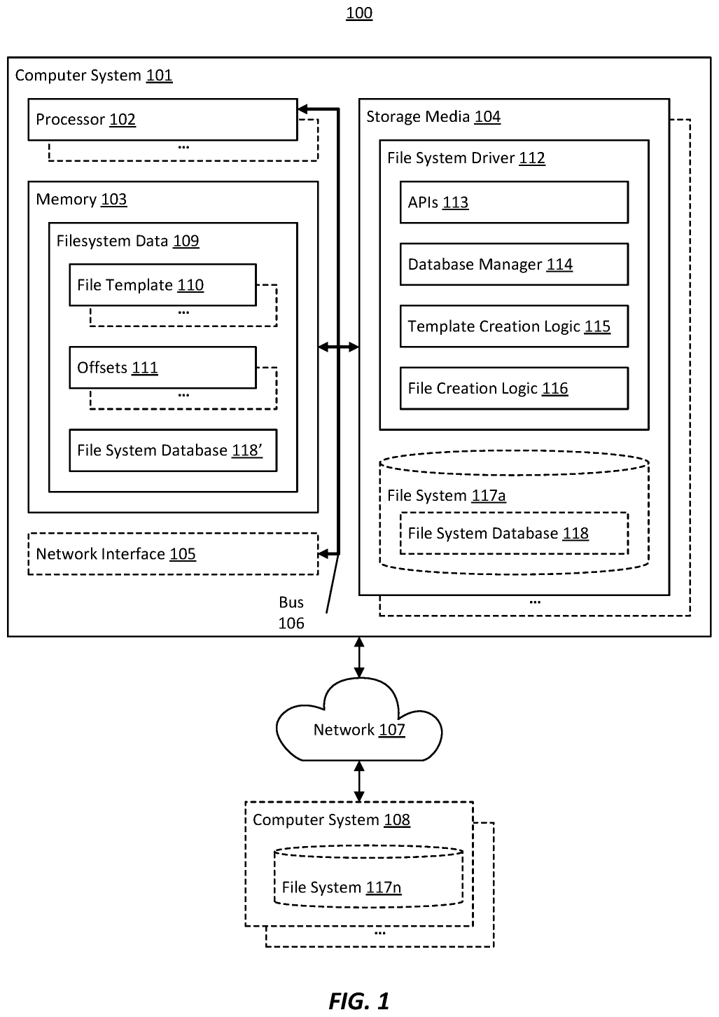

FIG. 1 illustrates an example computer architecture 100 that facilitates creating a file system file data record based on an internal file template. As shown, computer architecture 100 includes a computer system 101 comprising a processor 102 (or a plurality of processors), a memory 103, and one or more computer storage media (storage media 104), all interconnected by a bus 106. As shown, computer system 101 may also include a network interface 105 for interconnecting (via a network 107) to computer system(s) 108.

The storage media 104 is illustrated as storing computer-executable instructions implementing at least a file system driver 112 that operates to interface with, and manage, a file system 117. As depicted by file system 117a, in embodiments the file system 117 resides on one (or more) of the storage media 104. As depicted by file system 117n, in embodiments the file system 117 additionally, or alternatively, resides on one (or more) of computer system(s) 108. As examples, the file system 117 may be the New Technology File System (NTFS) designed by MICROSOFT CORP., the Resilient File System (ReFS) designed by MICROSOFT CORP., the Apple File System (APFS) designed by APPLE INC., the open-source B-tree file system (Btrfs), and the like.

Regardless of where the file system 117 resides, the file system 117 comprises a file system database 118. In embodiments, the file system database 118 is persistently stored along with the file system 117 (e.g., at storage media 104, at computer system(s) 108). As shown, the memory 103 includes file system data 109 managed by the file system driver 112. In embodiments, as indicated by file system database 118′, at least a portion of the file system database 118 is loaded by the file system driver 112 into this file system data 109, such as when the file system 117 is mounted by the file system driver 112.

As shown, the file system driver 112 includes APIs 113. In embodiments, the APIs 113 enable other software components (e.g., an operating system, a user space application, etc.) to call and interact with the file system driver 112. For example, among other things, the APIs 113 include at least one API that is used to create a new file within the file system 117. In embodiments, this file creation API is utilized called by an operating system file creation API, such as the CreateFile( ) API in the WINDOWS operating system.

As shown, the file system driver 112 also includes a database manager 114. In embodiments, the database manager 114 interacts with, and manages, the file system database 118 associated with the file system 117 (e.g., by modifying the file system database 118′ in memory 103, and then persisting those changes to the file system database 118 on disk). This includes creating, deleting, and managing database structures (e.g., tables, B+ tree nodes); creating, deleting, and managing database records (e.g., file data records); and the like. In embodiments, the database manager 114, and the file system database 118, is based on an extensible metadata layout (such as those used by NTFS or REFS), and each file data record is composed of multiple data elements (called attributes). Examples of attributes include the name of a file defined by the file data record, security access controls applied to the file, a main data stream and any alternate data streams associated with the file, etc.

In accordance with the embodiments herein, the file system driver 112 is configured to improve the performance of file creation by creating, and then using, a set of internal file data record templates (file templates) that each has common sets of attributes for newly created files (e.g., when using operating system APIs, such as the CreateFile( ) API in the WINDOWS operating system).

To the accomplishment of the foregoing, the file system driver 112 is depicted as including template creation logic 115 and file creation logic 116. In embodiments, the template creation logic 115 creates a set of internal file templates (e.g., file template 110) corresponding to common sets of attributes for newly created files, and the file creation logic 116 utilizes these file templates when creating file data records for new files.

In embodiments, the template creation logic 115 also creates a set of offsets 111 for each file template, with each offset identifying a location within the template (e.g., a specified number of bytes from a beginning of the template) that corresponds to a different attribute. In embodiments, the file creation logic 116 utilizes these offsets 111 to patch-up a template with unique attributes for a file when using that template to create the file.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

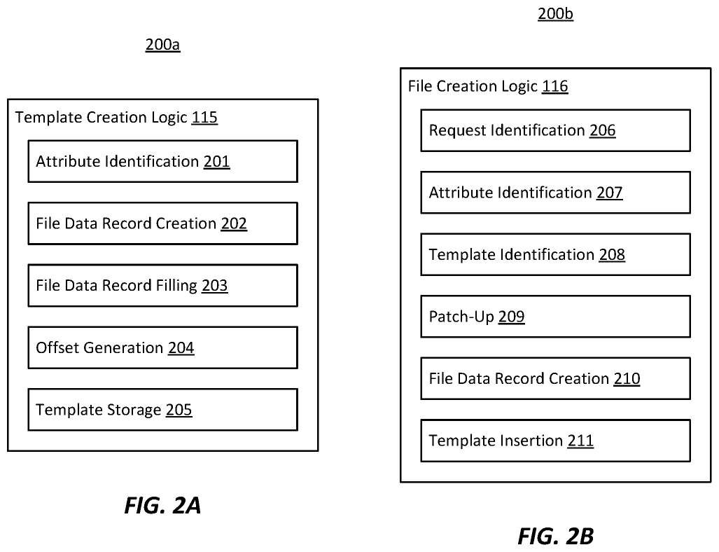

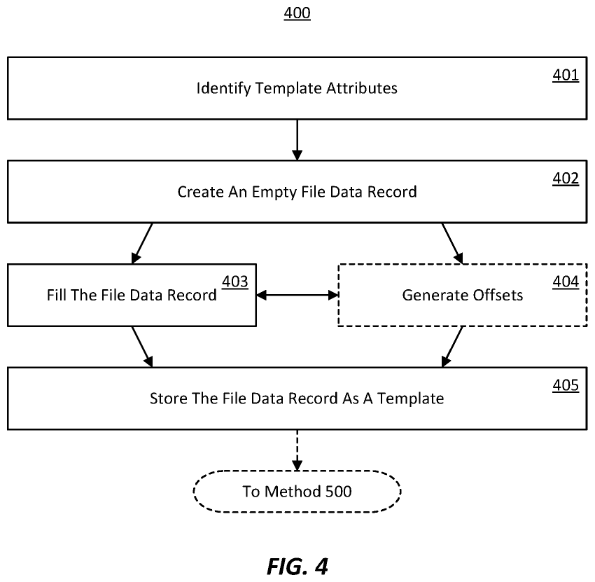

FIG. 2A illustrates an example 200a of components of the template creation logic 115, according to one or more embodiments. The components of the template creation logic 115 are described further in connection with FIG. 4, which illustrates a flow chart of an example method 400 for creating a file template. In embodiments, instructions for implementing method 400 are encoded as computer-executable instructions (e.g., template creation logic 115) stored on a computer program product (e.g., storage media 104) that are executable by a processor (e.g., processor 102) to cause a computer system (e.g., computer system 101) to perform method 400.

In embodiments, the method 400 operates at file system mount time, such that the template creation logic 115 creates a new set of file templates each time the file system 117 is mounted by the file system driver 112. Thus, some embodiments of method 400, creating the set of file templates is performed at file system mount. In embodiments, creating a new set of file templates each time the file system 117 is mounted facilitates creation of file templates that are consistent, and compatible, with the file system database 118—even when there are updates to a format of the file system database 118. For example, if a format of the file system database 118 is updated to a new version when offline (e.g., when the file system 117 is not mounted), then the template creation logic 115 can create a set of file templates that are formatted consistent with that new version. In embodiments, method 400 could also be triggered by an update to a format of the file system database 118, such as when a format of the file system database 118 is updated to a new version when online (e.g., when the file system 117 is mounted). Additionally, or alternatively, method 400 could operate in connection with file system creation.

In some embodiments, method 400 is performed repetitively to create a plurality of internal file templates for a given file system, with one file template (e.g., file template 110 for file system 117) being created by each performance of method 400. Thus, when repeating method 400, the template creation logic 115 creates a set comprising a plurality of internal file templates for a given file system. In embodiments, each file template corresponds to a different set of commonly used attributes. For example, the template creation logic 115 may create a different file template for each of a plurality of common call patterns to an operating system file creation API (e.g., the CreateFile( ) API in the WINDOWS operating system), and perform method 400 for each of those common call patterns.

Referring to FIG. 2A, the template creation logic 115 is illustrated as including an attribute identification component 201. In embodiments, the attribute identification component 201 identifies a set of attributes for a given file template (e.g., file template 110) that is to be created for a file system (e.g., file system 117). For example, for a given call pattern to the CreateFile( ) API in the WINDOWS operating system, the attribute identification component 201 identifies a set of attributes that would be associated with a new file created using that call pattern. In embodiments, this set of attributes is based on API parameters, inherited properties (e.g., from a volume associated with file system 117), a security context of the file system 117, and the like.

Referring to FIG. 4, method 400 comprises an act 401 of identifying template attributes. In some embodiments, act 401 comprises identifying a set of attributes for the file template. In an example, in connection with creation of file template 110 for file system 117, the attribute identification component 201 identifies a set of attributes that would be associated with a newly created file based, for example, on API parameters, inherited properties (e.g., from a volume associated with file system 117), a security context of the file system 117, and the like.

Referring to FIG. 2A, the template creation logic 115 is illustrated as including a file data record creation component 202. In embodiments, the file data record creation component 202 creates a new empty file data record using a format appropriate to the file system database 118. While this new empty file data record could be created as part of the file system database 118, in embodiments the file data record creation component 202 creates the new empty file data record as a memory object that is separate from the file system database 118. In some embodiments, the file data record creation component 202 utilizes the database manager 114 to create the new empty file data record—such as by utilizing functionality within the database manager 114 that would normally be used to create a new empty file data record for a new file.

In one example, the file data record creation component 202 creates an empty file data record configured to store a key-value pair, and which includes a key portion configured to store a file name, and a value portion configured to store a blob comprising a plurality of attributes. In an example, this empty file data record is structured to be used as a row of a data table, such as a directory table within file system database 118.

Referring to FIG. 4, method 400 also comprises an act 402 of creating an empty file data record. In some embodiments, act 402 comprises creating a file data record for the file template. In an example, the file data record creation component 202 creates a new empty file data record using a format appropriate to the file system database 118, such as by utilizing functionality within the database manager 114.

Referring to FIG. 2A, the template creation logic 115 is illustrated as including a file data record filling component 203. In embodiments, the file data record filling component 203 fills the new file data record created by the file data record creation component 202 with attribute data that would be appropriate for when creating a new file using the set of attributes identified by the attribute identification component 201. Much like the file data record creation component 202, in embodiments the file data record filling component 203 utilizes the database manager 114 to fill the file data record—such as by utilizing functionality within the database manager 114 that would normally be used to populate a file data record with attribute data as part of creating a new file. In embodiments, as a result of operation of the file data record filling component 203, the file data record created by the file data record creation component 202 is in a state that would be comparable to a file data record that would have been created when creating a new file using conventional techniques.

In one example, the file data record creation component 202 fills a value portion of a file data record configured to store a key-value pair. In embodiments, this filled value portion comprises a blob of data that, when interpreted by the database manager 114, represents a plurality of data tables (e.g., in the form of one or more B+ trees) storing the attribute data filled by the file data record filling component 203 into the value portion of a file data record.

Referring to FIG. 4, method 400 also comprises an act 403 of filling the file data record. In some embodiments, act 403 comprises, for each attribute in the set of attributes, calling a file system database API to add the attribute to the file data record. In an example, the file data record filling component 203 repeatedly calls an API of the database manager 114 to fill the new empty file data record created in act 402 with attributes appropriate to the set of attributes identified in act 401.

Referring to FIG. 2A, the template creation logic 115 is illustrated as including an offset generation component 204. In embodiments, the offset generation component 204 generates a set of offsets, with each offset corresponding to a location of an attribute filled into the file data record by the file data record filling component 203. In embodiments, each offset is a specified number of bytes from a beginning byte of the file data record (e.g., if the template comprises the entire file data record), is a specified number of bytes from a beginning byte of a particular section of the file data record (e.g., if the template comprises a portion of the file data record, such a value portion of a file data record configured to store a key-value pair), etc.

Referring to FIG. 4, in embodiments, method 400 also comprises an act 404 of generating offsets. In some embodiments, act 404 comprises generating a set of offsets, each offset identifying a memory location, within the file template, of a corresponding attribute. In an example, the offset generation component 204 generates a set of offsets 111, each corresponding to a location of an attribute filled into the file data record by the file data record filling component 203. In embodiments, each of these offsets 111 represent an offset (e.g., a specified number of bytes) from a beginning byte of a template generated by method 400. The offsets 111 generated in act 404 enable the location of various attributes within file template 110 to be later identified (e.g., by patch-up component 209, discussed infra).

Notably, there is no express ordering illustrated among act 403 and act 404. As such, in various embodiments, these acts could be performed serially or in parallel. In some embodiments, these acts are performed in parallel, such that the offset generation component 204 generates an offset to one or more attributes as those attributes are filled by the file data record filling component 203.

Referring to FIG. 2A, the template creation logic 115 is illustrated as including a template storage component 205. In embodiments, the template storage component 205 stores a file template (e.g., file template 110) based on the file data record filled by the file data record filling component 203. In some embodiments, the template storage component 205 stores an entirety of the file data record as a template. In other embodiments, the template storage component 205 stores a subset of the file data record (e.g., a value portion of a file data record configured to store a key-value pair).

Referring to FIG. 4, method 400 also comprises an act 405 of storing the file data record as a template. In some embodiments, act 405 comprises storing at least a subset of the file data record as the file template. In an example, the template storage component 205 stores at least a portion of the file data record generated in act 402, and filled with attributes in act 403, as file template 110.

As a result of performance of method 400 one or more times, the template creation logic 115 generates a set of one or more file templates, each of which is associated with a different set of common attributes. Thus, when a new file is being created that has one of these sets of common attributes, the file creation logic 116 operates to copy an appropriate file template (e.g., file template 110) into a new file data record in a single transaction-rather than using multiple file system database operations by the database manager 114 to write those attributes to the new file data record as is conventional. Due to generation of corresponding offsets (e.g., offsets 111), the file creation logic 116 can “patch up” that template with unique data—such as file name, file creation time, and the like—prior copying it into a new file data record. Thus, creation of a new file data record (including the addition of the unique data) can be performed using a single transaction within a file system database (i.e., a single atomic database operation by the database manager 114, from the point of view of crash recovery and file system transactional semantics), even when the new file data record contains unique data.

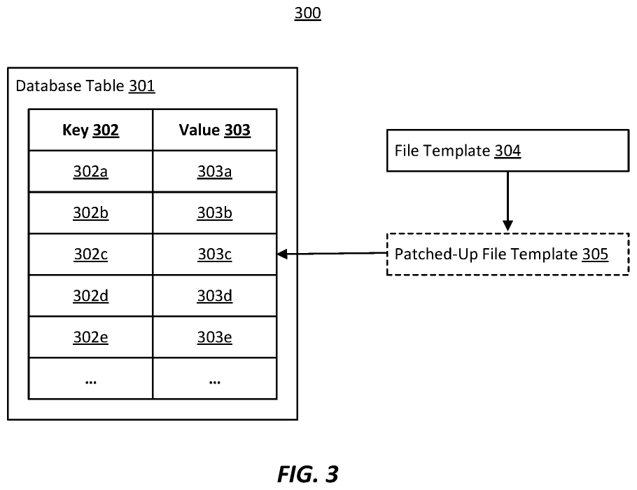

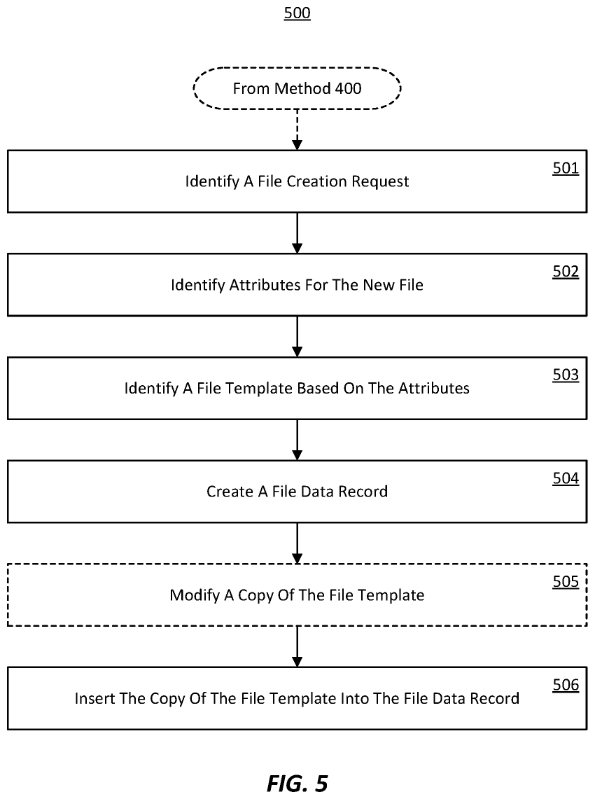

To describe the file creation process further, FIG. 2B illustrates an example 200b of components of the file creation logic 116, according to one or more embodiments, which leverages file templates created by the template creation logic 115 when creating a new file. The components of the file creation logic 116 are described further in connection with FIG. 5, which illustrates a flow chart of an example method 500 for creating a file system file data record based on a file template; and FIG. 3, which illustrates an example 300 of inserting a file template into a file data record. In embodiments, instructions for implementing method 500 are encoded as computer-executable instructions (e.g., file creation logic 116) stored on a computer program product (e.g., storage media 104) that are executable by a processor (e.g., processor 102) to cause a computer system (e.g., computer system 101) to perform method 500.

Referring to FIG. 2B, the file creation logic 116 is illustrated as including a request identification component 206. In embodiments, the request identification component 206 identifies a request, at APIs 113, for creation of a new file. In embodiments, the request originates from a user space program directly, or from via an operating system API (e.g., the CreateFile( ) API in the WINDOWS operating system).

Referring to FIG. 5, method 500 comprises an act 501 of identifying a file creation request. In some embodiments, act 501 comprises identifying an API request to create a new file. In an example, the request identification component 206 identifies a request, at APIs 113, for creation of a new file within file system 117.

Referring to FIG. 2B, the file creation logic 116 is illustrated as including an attribute identification component 207. In embodiments, the attribute identification component 207 identifies one or more attributes associated with a request, identified by the request identification component 206, for creation of a new file. In embodiments, the attribute identification component 207 identifies one or more expressly specified attributes—such as attributes specified as part of a call to an operating system API, and/or attributes specified as part of a call to APIs 113. Additionally, or alternatively, in embodiments the attribute identification component 207 identifies one or more implicit attributes—such as an inherited attribute for the new file. Examples of implicit attributes include an attribute inhered from a hierarchical location of the new file within a directory, a volume, etc.; or an attribute implied by a security context of a file handle for the new file. Examples of attributes include a file name, a file creation time, a file access time, a file modification time, one or more sets of file permissions, a security descriptor, integrity protection status, compression status, and the like. In one specific example, the attribute identification component 207 identifies a set of attributes that includes an integrity protection status—such as integrity protection being on for a newly-created file, or integrity protection being off for a newly-created file.

Referring to FIG. 5, method 500 also comprises an act 502 of identifying attributes for the new file. In some embodiments, act 502 comprises, based at least on identifying the API request, identifying a set of attributes associated with the new file. In an example, the attribute identification component 207 identifies one or more expressly specified and/or one or more implicit attributes associated with the request for creation of a new file that was identified in act 501. In some embodiments of act 502, identifying the set of attributes associated with the new file comprises at least one of, (i) identifying a first attribute based on a parameter of the API request, (ii) identifying a second attribute based on an inherited property for the new file, or (iii) identifying a third attribute based on a security context of a file handle.

Referring to FIG. 2B, the file creation logic 116 is illustrated as including a template identification component 208. In embodiments, the template identification component 208 uses a set of attributes identified by the attribute identification component 207 to identify an internal file template, such as file template 110. In embodiments, the template identification component 208 operates by comparing the set of attributes identified by the attribute identification component 207 with a set of attributes that were used to generate a given file template. For example, the template identification component 208 identifies the file template 110 when the set of attributes identified by the attribute identification component 207 match a set of attributes used by the template creation logic 115 to generate file template 110 (i.e., using method 400).

Referring to FIG. 5, method 500 also comprises an act 503 of identifying a file template based on the attributes. In some embodiments, act 503 comprises identifying a selected file template, from among a set of file templates, that is associated with the set of attributes. In an example, the template identification component 208 identifies the file template 110 based on the set of attributes identified in act 502 matching a set of attributes used in method 400 to generate file template 110.

As noted, in connection with discussion of the file data record filling component 203, in one example, the file data record creation component 202 fills a value portion of a file data record configured to store a key-value pair, and this filled value portion comprises a blob of data that, when interpreted by the database manager 114, represents a plurality of data tables (e.g., in the form of one or more B+ trees) storing the attribute data. Thus, in some embodiments of act 503, the selected file template comprises one or more tables.

Referring to FIG. 2B, the file creation logic 116 is illustrated as including a file data record creation component 210. In embodiments, the file data record creation component 210 creates a new empty file data record using a format appropriate to the file system database 118, either as part of the file system database 118, or as a memory object that is separate from the file system database 118 (e.g., for later insertion into the file system database 118).

Referring to FIG. 5, method 500 also comprises an act 504 of creating a file data record. In some embodiments, act 504 comprises creating a file data record for the new file within a file system database. In an example, the file data record creation component 210 creates a new empty file data record using a format appropriate to the file system database 118. This empty file data record is for storing attributes for the new file requested in act 501.

For instance, referring to FIG. 3, example 300 includes a database table 301 (e.g., as part of the file system database 118′). This database table 301 stores file data records as key-value pairs, and thus the database table 301 comprises a key portion 302 and a value portion 303. Thus, in some embodiments of method 500, the file data record comprises a key-value pair. In example 300, the row corresponding to key portion 302c and value portion 303c is a new row corresponding to the file data record created in act 504, and which will be filled by file template 304 (e.g., file template 110). In embodiments, the key portion 302c stores a file name of the new file, and the value portion 303c is used to store attributes of that file. Thus, in some embodiments of method 500, a key of the key-value pair comprises a name of the new file, and a key of the key-value pair comprises one or more file attributes.

Referring to FIG. 2B, the file creation logic 116 is illustrated as including a patch-up component 209. In embodiments, the patch-up component 209 creates an in-memory copy of a file template (e.g., file template 110), and then utilizes offsets (e.g., offsets 111) associated with that file template to modify a value of one or more attributes within the copy of the file template. For example, the patch-up component 209 modifies attributes specific to the file being created, such as file name, file creation time, and the like. In embodiments, the patch-up component 209 identifies and modifies a memory location within the copy of the file template corresponding to an attribute, based on adding an offset (e.g., number of bytes) corresponding to the attribute (as identified from offsets 111) to a base memory address at which the copy of the file template is stored.

Referring to FIG. 5, in embodiments, method 500 comprises an act 505 of modifying a copy of the file template. In some embodiments, act 505 comprises modifying an attribute within the copy of the selected file template prior to inserting the copy of the selected file template into the file data record for the new file. In an example, the patch-up component 209 creates an in-memory copy of file template 110, and then utilizes offsets 111 to modify the value of one or more attributes within the copy of the file template 110. Thus, when performed, act 505 modifies the file template 110 with data unique to the file being created. In some embodiments of act 505, modifying the attribute within the copy of the selected file template comprises identifying a memory location within the copy of the selected file template, based on an offset corresponding to the attribute and modifying a memory value at the memory location.

Referring to FIG. 3, example 300 shows that the file template 304 is used to create a patched-up file template 305, which is a modified copy of the file template 304.

Referring to FIG. 2B, the file creation logic 116 is illustrated as including a template insertion component 211. In embodiments, the template insertion component 211 inserts the template identified by the template identification component 208, or a copy thereof (e.g., as created by the patch-up component 209), into the file data record created by the file data record creation component 210. In some embodiments, the file data record creation component 210 created the file data record as part of the file system database 118. In these embodiments, the template insertion component 211 copies the template (or a modified copy thereof) into that file data record within the file system database 118 (e.g., using APIs of the database manager 114). In other embodiments, the file data record creation component 210 created the file data record as a memory object that is separate from the file system database 118. In these embodiments, the template insertion component 211 copies the template (or a modified copy thereof) into that memory object, and then inserts that memory object into the file system database 118 (e.g., using APIs of the database manager 114).

Referring to FIG. 5, method 500 also comprises an act 506 of inserting the copy of the file template into the file data record. In some embodiments, act 506 comprises inserting a copy of the selected file template into the file data record for the new file. In an example, the template insertion component 211 inserts the file template 110, or a copy thereof that has been modified by the patch-up component 209 in act 505, into the data record created in act 504.

Referring to FIG. 3, example 300 shows that the file template 304 (or, if present, the patched-up file template 305) is inserted into value portion 303c. Thus, in some embodiments of method 500, inserting the copy of the selected file template into the file data record comprises inserting the copy of the selected file template as a value of the key-value pair.

In embodiments, use of file templates to fill a file data record—in the manner outlined in method 500—enables the database manager 114 to create the new file data record within the file system database 118 using a single atomic transaction. Thus, in embodiments of method 500, creating the file data record for the new file within the file system database is a single transaction within a file system database.

In embodiments, the database manager 114 creates a transaction log. By creating the new file data record within the file system database 118 using a single transaction, this means that only this single transaction needs to be logged in the transaction log—e.g., as an undo record and/or a redo record. Thus, in embodiments, method 500 also comprises creating one or more of an undo record or a redo record that logs creation of the file data record for the new file within the file system database.

Notably, creating a new file data record using a single transaction within a file system database—rather than using multiple database transactions as was done previously—leads to a reduction of data stored in a transaction log (e.g., a single undo and redo record pair for the single database transaction, rather than a different undo and redo record pair for each of a plurality of database transaction), and a reduction of work on crash recovery (e.g., less transaction log data to replay). Creating a new file data record as using a single transaction also takes a single lock on the file system database (e.g., when copying a template into a file data record), rather than taking multiple locks on the file system database (e.g., as each attribute that is added to a file data record) as was done previously. Overall, this leads to reduced data storage requirements, more efficient use of processor resources, and lower energy use than prior file creation techniques.

In FIG. 4, method 400 is shown as potentially preceding method 500; and in FIG. 5, method 500 is shown as potentially occurring after method 400. Thus, in some embodiments, method 500 comprises creating the set of file templates prior to identifying the API request (i.e., by performing method 400).

Accordingly, the embodiments herein create a set of internal file templates that each has common sets of attributes for newly created files (e.g., when using operating system APIs). Then, when a new file is being created that has one of these common sets of attributes, the embodiments herein copy an appropriate file template into a new file data record, while potentially “patching up” the template with unique data prior copying it into a new file data record. Thus, creation of a new file data record can be performed using a single transaction within a file system database.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system (e.g., computer system 101) that includes computer hardware, such as, for example, one or more processors (e.g., processor 102) and system memory (e.g., memory 103), as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 104). Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its essential characteristics. Such embodiments may include a data processing device comprising means for carrying out one or more of the methods described herein; a computer program comprising instructions which, when the program is executed by a computer, cause the computer to carry out one or more of the methods described herein; and/or a computer-readable medium comprising instructions which, when executed by a computer, cause the computer to carry out one or more of the methods described herein. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

1. A method, implemented at a computer system that includes a processor, for creating a file system file data record based on a file template, the method comprising:
identifying an application programming interface (API) request to create a new file;
based at least on identifying the API request, identifying a set of attributes associated with the new file;
identifying a selected file template, from among a set of file templates, that is associated with the set of attributes; and
creating a file data record for the new file within a file system database, including inserting a copy of the selected file template into the file data record for the new file.

2. The method of claim 1, wherein identifying the set of attributes associated with the new file comprises at least one of:
identifying a first attribute based on a parameter of the API request;
identifying a second attribute based on an inherited property for the new file; or
identifying a third attribute based on a security context of a file handle.

3. The method of claim 1, wherein creating the file data record for the new file within the file system database, including inserting a copy of the selected file template into the file data record for the new file, is performed using a single transaction within the file system database.

4. The method of claim 3, further comprising creating a single undo and redo record pair for the single transaction.

5. The method of claim 1, further comprising modifying an attribute within the copy of the selected file template prior to inserting the copy of the selected file template into the file data record for the new file.

6. The method of claim 5, wherein modifying the attribute within the copy of the selected file template comprises:
identifying a memory location within the copy of the selected file template, based on an offset corresponding to the attribute; and
modifying a memory value at the memory location.

7. The method of claim 1, wherein the file data record comprises a key-value pair, and wherein inserting the copy of the selected file template into the file data record comprises inserting the copy of the selected file template as a value of the key-value pair.

8. The method of claim 7, wherein a key of the key-value pair comprises a name of the new file.

9. The method of claim 1, wherein the selected file template comprises one or more tables.

10. The method of claim 1, further comprising creating the set of file templates prior to identifying the API request.

11. The method of claim 10, wherein creating each file template in the set of file templates comprises:
identifying a set of attributes for the file template;
creating a file data record for the file template;
for each attribute in the set of attributes, calling a file system database API to add the attribute to the file data record; and
storing at least a subset of the file data record as the file template.

12. The method of claim 11, wherein creating each file template in the set of file templates also comprises generating a set of offsets, each offset identifying a memory location, within the file template, of a corresponding attribute.

13. The method of claim 10, wherein creating the set of file templates is performed at file system mount.

14. A computer system for creating file system a file data record based on a file template, comprising:
a processor; and
a computer storage media that stores computer-executable instructions that are executable by the processor to cause the computer system to at least:
identify an application programming interface (API) request to create a new file;
based at least on identifying the API request, identify a set of attributes associated with the new file;
identify a selected file template, from among a set of file templates, that is associated with the set of attributes; and
create a file data record for the new file within a file system database, including inserting a copy of the selected file template into the file data record for the new file.

15. (canceled)

16. The computer system of claim 14, wherein identifying the set of attributes associated with the new file comprises at least one of:
identifying a first attribute based on a parameter of the API request;
identifying a second attribute based on an inherited property for the new file; or
identifying a third attribute based on a security context of a file handle.

17. The computer system of claim 14, wherein creating the file data record for the new file within the file system database, including inserting a copy of the selected file template into the file data record for the new file, is performed using a single transaction within the file system database.

18. The computer system of claim 17, wherein the computer-executable instructions are also executable by the processor to cause the computer system to create a single undo and redo record pair for the single transaction.

19. The computer system of claim 14, wherein the computer-executable instructions are also executable by the processor to cause the computer system to modify an attribute within the copy of the selected file template prior to inserting the copy of the selected file template into the file data record for the new file.

20. The computer system of claim 14, wherein the file data record comprises a key-value pair, and wherein inserting the copy of the selected file template into the file data record comprises inserting the copy of the selected file template as a value of the key-value pair.

21. A computer program product comprising a computer storage media that stores computer-executable instructions that are executable by a processor to cause a computer system to create a file system file data record based on a file template, the computer-executable instructions including instructions that are executable by the processor to cause the computer system to at least:
identify an application programming interface (API) request to create a new file;
based at least on identifying the API request, identify a set of attributes associated with the new file;
identify a selected file template, from among a set of file templates, that is associated with the set of attributes; and
create a file data record for the new file within a file system database, including inserting a copy of the selected file template into the file data record for the new file.
